(19) United States
(12) Patent Application Publication
(10) Pub. No.: US 2016/0222918 A1
(43) Pub. Date: Aug. 4, 2016

(54) DEVICE FOR SELF-PRESSURIZATION OF A TANK

(71) Applicant: SNECMA, Paris (FR)

(72) Inventors: Gérard ROZ, Pressagny l'Orgueilleux (FR); David HAYOUN, Paris (FR); Nicolas RAVIER, Vernon (FR)

(73) Assignee: SNECMA, Paris (FR)

(21) Appl. No.: 15/024,466

(22) PCT Filed: Sep. 18, 2014
(86) PCT No.: PCT/FR2014/052323

§ 371 Date: Mar. 24, 2016

(30) Foreign Application Priority Data
Sep. 30, 2013 (FR) 1359392

(51) Int. Cl. F02K 9/42; F02K 9/44

(52) U.S. Cl. CPC F02K 9/425; F02K 9/44

(57) ABSTRACT

A propulsion assembly (1, 201) for a rocket, comprising a tank (2) configured to contain a propellant, an engine having a combustion chamber (9), a propellant feed pipe (11) extending between the tank (2) and the combustion chamber (9) and having an isolation valve (24) arranged therein, and a heater (15) having an inlet connected to the feed pipe (11) and an outlet connected to the tank (2). The inlet of the heater comprises an inlet pipe (13a) connected firstly to the feed pipe (11) downstream from the isolation valve (24) and secondly to a neutral fluid feed (31).

The invention relates to a propulsion assembly for a rocket, comprising a tank configured to contain a propellant, an engine having a combustion chamber, a propellant feed pipe extending between the tank and the combustion chamber and having an isolation valve arranged therein, and a heater having an inlet connected to the feed pipe and an outlet connected to the tank.

The engine is usually an engine from which the gas leaving the combustion chamber is exhausted via a nozzle so as to develop thrust. The combustion is the result of mixing propellants, respectively a fuel such as hydrogen or methane and an oxidizer such as oxygen.

In general, in such propulsion assemblies, it is necessary to maintain the propellant tanks under pressure in order to ensure that the propellants flowing towards the engine flow at a regular rate. When one of the propellants is liquid oxygen, pressure is maintained in the oxygen tank by injecting into the gas space of the tank either a neutral gas such as helium, or else oxygen in the vapor phase as obtained by vaporization in a heater for heating liquid oxygen coming from the tank. Under such circumstances, the liquid oxygen that is to be vaporized is taken directly from the oxygen feed pipe of the combustion chamber.

Nevertheless, since oxygen needs to be in the liquid phase upstream from the heater and in the gaseous phase on returning to the tank, there is a risk of oxygen existing in two phases inside the heater. That greatly diminishes the efficiency of the heater, and bubbles run the risk of going back along the liquid oxygen circuit, which must be avoided. In order to ensure that the oxygen remains in a single phase inside the heater, an isolation system (commonly called an “anti-flood” system) is provided upstream from the heater. This system must prevent the oxygen that is taken from the feed pipe penetrating into the heater so long as its pressure is lower than the critical pressure of oxygen. Generally, the anti-flood system consists in a threshold valve, referred to as the oxygen tank pressurization anti-flood valve and dedicated solely to this function.

With such a valve, the pressure of oxygen increases at the inlet of the heater until it reaches the passing pressure of the valve, which passing pressure is selected to be higher than the critical pressure of oxygen. At this passing pressure, oxygen is thus in a supercritical phase. Given its pressure, it can pass through the valve and enter into the heater, where its temperature increases and in which it remains in a supercritical phase. On leaving the heater, the supercritical oxygen can expand and enter into the gaseous phase in the tank in order to keep it under pressure.

Nevertheless, using an anti-flood valve represents extra cost and additional weight for the propulsion assembly. It is well known that weight in particular is a crucial criterion in the design of rockets. Furthermore, the anti-flood valve is generally a solenoid valve, which requires to control it based on the pressure of oxygen at the inlet to the heater, thereby further complicating the propulsion assembly. Finally, the opening and the closing of the anti-flood valve needs to be integrated in reliable and robust manner in the sequencing of the movements of all of the valves.

The object of the invention is thus to provide a propulsion assembly of the type specified in the introduction, that presents an anti-flood system, and that provides better performance, e.g. in terms of weight and/or cost, than propulsion assemblies of prior art types.

This object is achieved in a propulsion assembly of the type specified in the introduction by the fact that the inlet of the heater comprises an inlet pipe connected firstly to the feed pipe downstream from the isolation valve and secondly to a neutral fluid feed.

Thus, in the propulsion assembly, the isolation function of the anti-flood system is performed by the combination of the isolation valve and a neutral fluid feed. The isolation valve has another function of allowing or preventing the combustion chamber to be fed with propellant. The neutral fluid may be a control fluid that is used for hydraulic or pneumatic controls in certain other systems of the propulsion assembly, a sweeping fluid that is passed along cavities or pipes in order to empty them of some other fluid or in order to prevent some other fluid penetrating therein, a sealing fluid used in dynamic sealing systems, etc. The dedicated valve used in the prior art is thus replaced by the combination of systems that have other functions in the propulsion assembly, thereby leading to a saving in cost and, in particular, in weight.

The term “neutral fluid” is used herein to mean a fluid of composition that does not have any harmful consequences in a given context. In particular, the neutral fluid used herein must be inert relative to the propellant and to the pipes along which it passes. In other words, the neutral fluid must be capable of coexisting with the propellant without producing any physical or chemical reaction, and in particular without leading to combustion. The neutral fluid may, in particular, be helium.

By means of this system, the neutral fluid sweeps the inlet pipe of the heater and does not allow the propellant to penetrate into the heater until the pressure of the propellant is greater than the pressure of the neutral fluid. Furthermore, the need for servo-control is also avoided insofar as servo-controlling the opening of the anti-flood valve on the pressure of the oxygen entering into the inlet pipe of the heater is replaced by dynamic control using the pressure of the neutral fluid.

In certain embodiments, the propulsion assembly includes means configured to maintain the neutral fluid in the neutral fluid feed at a pressure that is not less than the critical pressure of the propellant. In this way, the neutral fluid sweeps the inlet pipe and allows the propellant to penetrate into the heater only if the pressure of the propellant is higher than the pressure of the neutral fluid, and thus higher than the critical pressure of the propellant. This makes it possible to ensure that the propellant is in a single phase inside the heater, thereby increasing the efficiency of the heater.

In certain embodiments, the neutral fluid feed includes a check valve allowing fluid to flow in the feed only in the direction going towards the heater. Thus, when the pressure of the propellant is higher than the pressure of the neutral fluid, the propellant cannot flow back along the neutral fluid feed. This prevents the propellant reaching the neutral fluid tank or interfering with other functions of the neutral fluid.

In certain embodiments, the propulsion assembly includes means for sweeping an injection head of the combustion chamber with the neutral fluid. In this way, downstream from the isolation valve, the sweeping of the injection head of the combustion chamber and the feeding of the injection head with propellant take place via a single pipe. This also provides a saving in terms of weight and cost.

In certain embodiments, the neutral fluid is helium. Helium, which is often used as a sweeping fluid or as a control fluid, is generally present in large quantity and at sufficient pressure in propulsion assemblies. In certain other embodiments, the neutral fluid is nitrogen.

In certain embodiments, the propellant is oxygen.

The propulsion assembly of the invention may include various types of engine.

The propulsion assembly may thus be made on the basis of a tap-off type engine, i.e. an engine in which some exhaust gas is taken off in order to deliver energy (in thermal and/or mechanical form) to certain portions of the engine.

In certain embodiments, the heater is a heat exchanger that co-operates with a pipe transporting combustion gases. The heater may be arranged at other locations.

Firstly it may be arranged at least in part in a wall of the combustion chamber and/or of an ejection nozzle of the engine. Nevertheless, it may also be arranged at a distance from the combustion chamber and the ejection nozzle of the engine. Under such circumstances, the propulsion assembly includes an exhaust gas circuit for taking exhaust gas from the engine and transporting it to the heater. Advantageously, the exhaust gas circuit may also enable the exhaust gas that has been taken off to be injected into at least one turbine in order to drive it/them. The turbine(s) may be part(s) of turbopump(s) for feeding the engine with propellant, e.g. the oxygen and hydrogen feed turbopumps.

When the taken-off exhaust gas is used for driving a turbine, provision may be made for the heat exchanger to be situated downstream from said at least one turbine in the exhaust gas take-off circuit.

When the taken-off exhaust gas is used for driving one or more turbines, the propulsion assembly may also include a bypass pipe connecting together two points of the exhaust gas circuit that are located respectively upstream and downstream from said at least one turbine. The bypass pipe must then be capable of being opened or closed by means of one or more valves depending on the mode of the operation of the engine: it must be capable of being closed in order to enable the turbines to be driven by the taken-off exhaust gas; otherwise it must be capable of being opened.

Instead of being taken directly from the combustion chamber, the exhaust gas may come from a gas generator. The gas generator is fed with propellant by inlet pipes that may take off a portion of the propellants from the feed pipes of the combustion chamber. Combustion takes place in the gas generator. Generally, combustion gases are then caused to flow through the heater and then drive one or more turbines.

The propulsion assembly may also be made on the basis of an expander type engine, i.e. an engine in which a heat transfer fluid, and in particular a propellant (specifically hydrogen) is taken off and vaporized in order to deliver energy (in thermal and/or mechanical form) to certain portions of the engine.

Thus, in certain embodiments, the heater is a heat exchanger that co-operates with a pipe transporting another propellant.

The propulsion assembly may include a circuit for a flow of a heat transfer fluid that comprises a primary heat exchanger enabling heat energy to be yielded by the exhaust gas to a heat transfer fluid, and the heater, which then constitutes a secondary heat exchanger enabling heat energy to be yielded by the heat transfer fluid to the oxygen. The use of an intermediate heat transfer fluid contributes flexibility in the arrangement of the heater and of the vaporized oxygen circuit.

The heat transfer fluid may enable energy to be transferred not only in thermal form, but also in mechanical form. For this purpose, in the propulsion assembly, the primary heat exchanger may be suitable for vaporizing the heat transfer fluid; and the heat transfer fluid flow circuit may serve to inject the vaporized heat transfer fluid into at least one turbine in order to drive it/them. Advantageously, vaporizing the heat transfer fluid serves to provide a fluid under pressure; the energy given to the heat transfer fluid can then be recovered via one or more turbines. The turbine(s) may in particular form part(s) of the turbopumps of the circuits for feeding propellants to the engine.

The heat transfer fluid is preferably another propellant that is consumed by the engine, e.g. hydrogen.

The invention can be well understood and its advantages appear better on reading the following detailed description of embodiments given as non-limiting examples. The description refers to the accompanying drawings, in which:

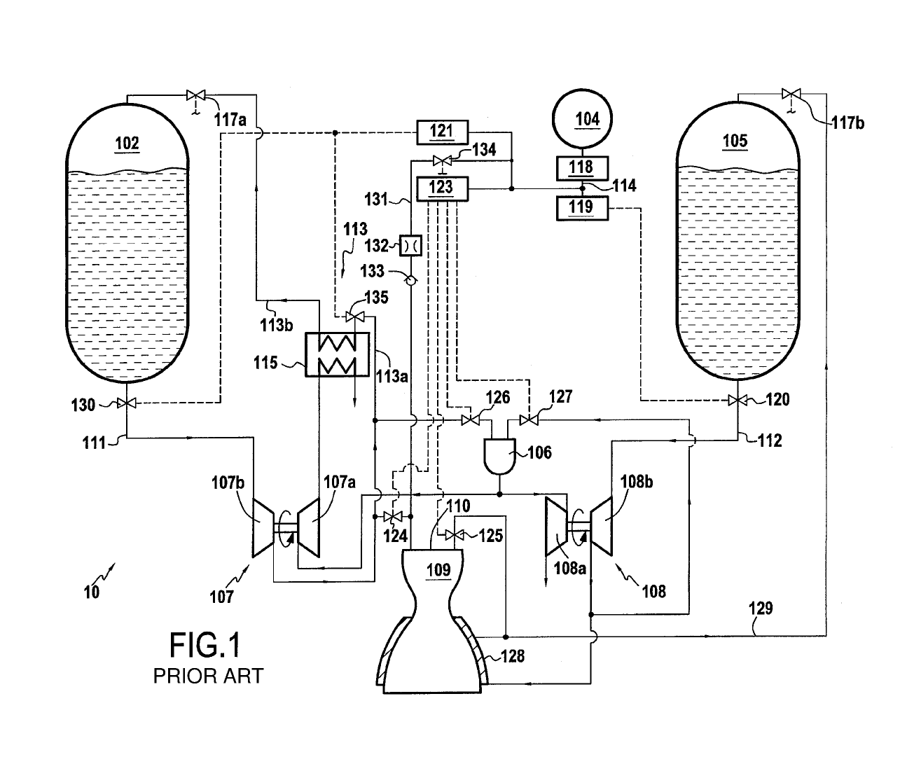

FIG. 1 is a diagrammatic view of a prior art propulsion assembly, based on a tap-off type engine;

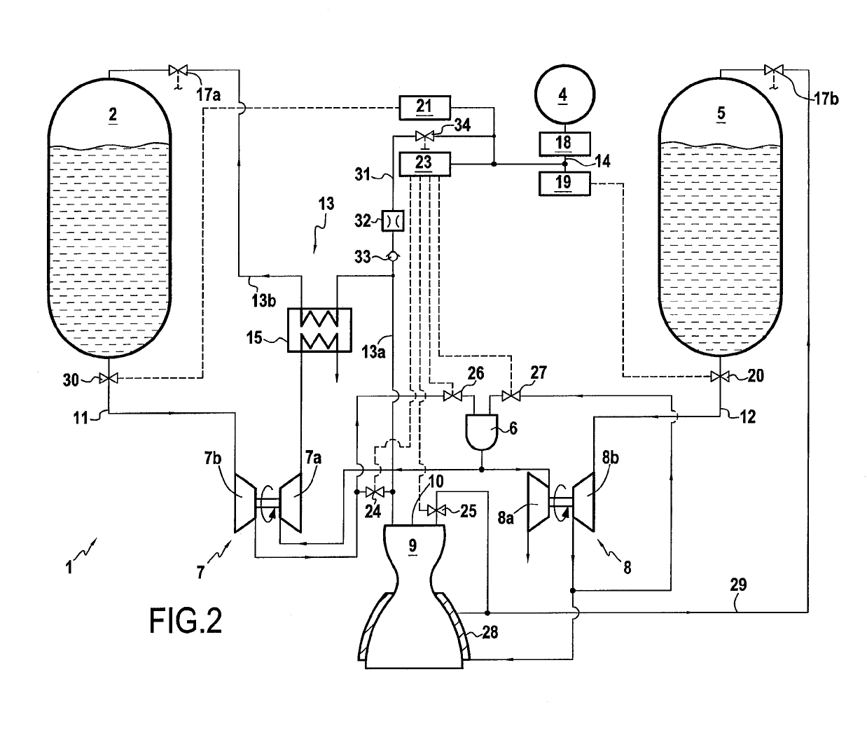

FIG. 2 is a diagrammatic view of a propulsion assembly of the invention based on a tap-off type engine; and

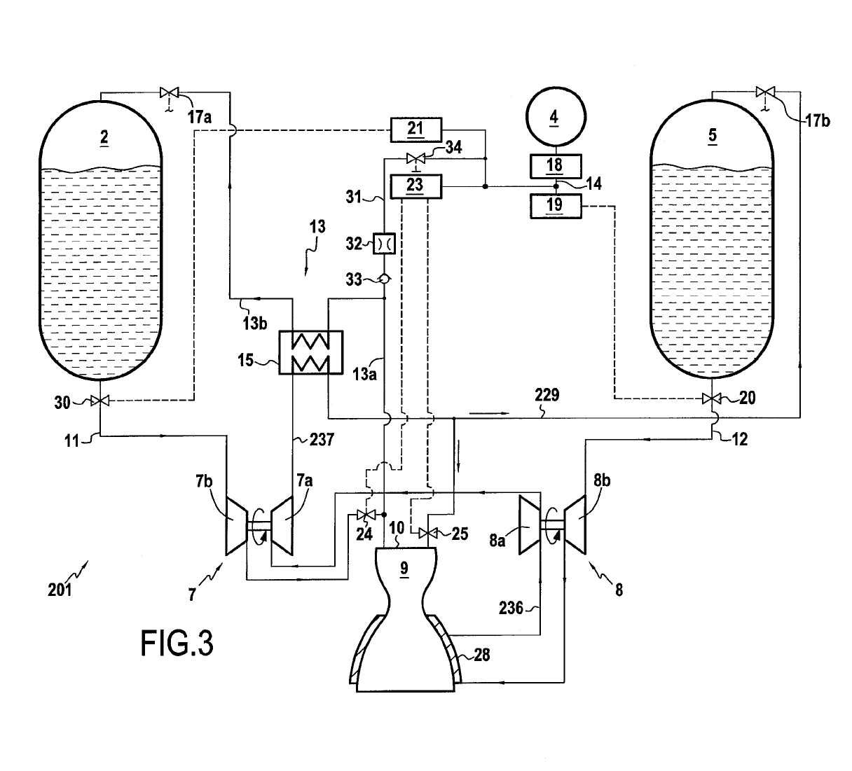

FIG. 3 is a diagrammatic view of a propulsion assembly of the invention, based on an expander type engine.

FIG. 1 is a diagram showing a prior art propulsion assembly 101, and more specifically a propulsion assembly comprising a Vulcain type engine for propelling a main cryogenic stage (MCS) of an Ariane 5 type launcher.

This propulsion assembly 101 comprises a first tank 102 containing oxygen—or more generally an oxidizer propellant—in liquid form as a first propellant, a second tank 104 containing gaseous helium under high pressure, in particular for the pneumatic control circuit of the propulsion assembly, and a third tank 105 containing hydrogen—or more generally a fuel propellant—in liquid form as a second propellant. The propulsion assembly 101 also has a pipe 111 for feeding the combustion chamber 109 with oxygen, and a pipe 112 for feeding the combustion chamber 109 with hydrogen, together with a gas generator 106.

The oxidizer propellant feed pipe 111 passes via a first turbopump 107 that comprises a turbine 107a and a pump 107b. The turbopump 107 is connected to the gas generator 106 in order to receive hot gas for actuating the turbine 107a, which drives the pump 107b in order to feed the combustion chamber 109 with oxidizer propellant. The fuel propellant feed pipe 112 passes via a second turbopump 108 comprising a turbine 108a and a pump 108b. The turbopump 108 is connected to the gas generator 106 in order also to receive hot gas from the gas generator 106 to drive the turbine 108a, thereby driving the pump 108b in order to feed the combustion chamber 109 with fuel propellant. The gas generator 106 is also connected to the outlet of the pump 107b and 108b in order to be fed with hydrogen and oxygen.

The propulsion assembly 101 also has a first pressurizer circuit 113 for pressurizing the first tank 102. The first pressurizer circuit 113 and the oxidizer propellant feed pipe 111 are connected together downstream from the first turbopump 107 and upstream from an oxygen chamber valve (OCV) 124 controlling the admission of oxygen into the combustion chamber 109. The OCV 124 forms an isolating valve. The first pressurizer circuit 113 has a first heat exchanger 115 for heating and vaporizing oxygen taken from the feed pipe 111 using heat coming from hot gas downstream from the turbine 107a of the first turbopump 107. This first heat exchanger forms a heater. The oxygen as vaporized in this way is used for pressurizing the first tank 102. The first pressurizer circuit 113 has an inlet pipe 113a and an outlet pipe 113b arranged respectively upstream and downstream from the first heat exchanger 115. The inlet pipe 113a also has a threshold valve 135 at the inlet to the first heat exchanger 115. This threshold valve 135, used as an anti-flood system, allows oxygen to pass to the first heat exchanger 115 only if the pressure of the oxygen is greater than the passing pressure of the valve 135. In order to avoid the oxygen being in two-phase form inside the first heat exchanger 115, the passing pressure of the valve 135 is selected to be greater than the critical pressure of oxygen (about 50.4 bar). The first pressurizer circuit 113 also has a valve 117a to prevent the first tank 102 from depressurizing when the pressure in the outlet pipe 113b is less than the pressure in the first tank 102, and to prevent excessive pressure in the tank 102, in particular when no fluid is leaving the tank via the oxygen feed pipe 111.

The control circuit 114 comprises a set of valves forming an inflation and expansion plate (IEP) 118 for controlling the flow of gaseous helium in both directions. This control circuit 114 comprises a hydrogen solenoid valve unit (HSVU) 119 for controlling a hydrogen feed valve (HFV) 120 for controlling the hydrogen feed pipe 112. In addition, between the IEP 118 and the HSVU 119, the control circuit 114 presents branch connections for feeding various solenoid valve units. The oxygen solenoid valve unit (OSVU) 121 serves to control an oxygen feed valve 130 for controlling the oxygen feed pipe 111, and for controlling the threshold valve 135. Finally, the chamber solenoid valve unit (CSVU) 123 serves to control the oxygen chamber valve (OCV), a hydrogen chamber valve (HCV) 125 controlling the admission of hydrogen into the combustion chamber 109, an oxygen generator valve (OGV) 126 controlling the admission of oxygen into the gas generator 106, and a hydrogen generator valve (HGV) 127 controlling the admission of hydrogen into the gas generator 106. Nevertheless, there is no need for the valves OCV 124, HCV 125, OGV 126, and HGV 127 to be controlled with helium. These valves could equally well be solenoid valves. The pressure of helium in the control circuit 114 is determined by the pressures needed for controlling the valves and is generally about 70 bar.

The second tank 104 is connected to the oxygen feed pipe 111 downstream from the OCV 124 by a feed 131. This feed 131 includes a constriction 132 for controlling the flow rate of helium along the feed 131. The conditions for feeding the feed 131 are selected so that the flow speed is sonic, such that the pressure downstream from the constriction 132 is independent of the pressure upstream from the constriction 132 so long as the ratio of upstream pressure over downstream pressure remains greater than about 2. Thus, the constriction 132 enables helium to be fed downstream from the constriction 132 at a certain rate and at a pressure value referred to as the helium calibration pressure. The feed 131 also has a check valve 133 to allow fluid to flow in the feed 131 only going away from the second tank 104, and a sweep valve 134 for allowing or preventing helium to flow in the feed 131. By way of example, the sweep valve 134 may be a solenoid valve.

In the hydrogen feed pipe 112 between the second turbopump 108 and the injection plate 110 of the combustion chamber 109, the propulsion assembly 101 also includes a second heat exchanger 128, referred to as a regenerative heat exchanger, that serves to cool the walls of the combustion chamber 109. In addition, in this propulsion assembly 101, a second pressurizer circuit 129 connects this hydrogen feed pipe 112 downstream from the second heat exchanger 128 to the third tank 105 in order to pressurize it with hydrogen that has been vaporized in the second heat exchanger 128 prior to being bled from the hydrogen feed pipe 112. The second pressurizer circuit 129 includes a valve 117b, similar to the valve 117a, for preventing the third tank 105 from losing pressure when the pressure in the second pressurizer circuit 129 is less than the pressure in the third tank 105, and for preventing excessive pressure in the tank 105, in particular when no fluid is leaving the tank via the hydrogen feed circuit 112.

Before starting the propulsion assembly 101, it is necessary to cool down the combustion chamber 109. This cooling generally lasts for less than three seconds, and may be performed by causing liquid hydrogen to flow into the combustion chamber via the hydrogen feed pipe 112. During this step, the HCV 125 is thus open. In contrast, the OCV 124 is closed so no oxygen flows in the first pressurizer circuit 113. The sweep valve 134 is open. The helium flowing in the feed 131, at the rate adjusted by the constriction 132, joins the feed pipe 111 downstream from the OCV 124 and is sent to the combustion chamber 109. Thus, this helium prevents the hydrogen that is used for cooling the combustion chamber 109 from flowing into the oxygen feed pipe 111. This avoids having a mixture of hydrogen and oxygen upstream from the combustion chamber, which could lead to combustion and could damage certain portions of the propulsion assembly 101. During cooling, the valves 117a and 135a are closed to prevent the first tank 102 from losing pressure when the pressure in the outlet pipe 113b is lower than the pressure in the first tank 102, and otherwise to prevent excessive pressure in the tank 102.

FIG. 2 shows a propulsion assembly 1 in an embodiment of the present invention that is of lower mass and less complexity than the above prior art. Unless mentioned to the contrary, the propulsion assembly 1 is identical to the propulsion assembly 101. Consequently, the description relates only to those characteristics of the propulsion assembly 1 that differ from the propulsion assembly 101. Furthermore, elements that are identical or similar are given the same references, ignoring the hundreds digit, for both propulsion assemblies.

The propulsion assembly 1 is made on the basis of a tap-off type engine and comprises a first pressurizer circuit 13 connecting the oxidizer propellant feed pipe 11 to the first tank 2 in order to pressurize the first tank 2. The first pressurizer circuit 13 and the oxidizer propellant feed pipe 11 are connected together downstream from the oxygen chamber valve 24. The first pressurizer circuit 13 has a first heat exchanger 15 for heating and vaporizing oxygen taken from the feed pipe 11 with heat coming from the hot gas downstream from the turbine 7a of the first turbopump 7. This first heat exchanger 15 forms a heater. The oxygen as vaporized in this way is for pressurizing the first tank 2. The first pressurizer circuit 13 has an inlet pipe 13a and an outlet pipe 13b placed respectively upstream and downstream from the first heat exchanger 15. Unlike the prior art propulsion assembly, the inlet pipe 13a does not have a threshold valve at the inlet of the first heat exchanger 15 as an anti-flood system. The anti-flood system that is used is described below.

The second tank 4 is connected firstly to the oxygen feed pipe 11 downstream from the OCV 24 in order to provide helium sweeping while cooling the combustion chamber 9, and also to the inlet pipe 13a upstream from the first heat exchanger 15 by a feed 31. The feed 31 includes a constriction 32, a check valve 33, and a sweep valve 34.

In this embodiment, the anti-flood system comprises the isolating valve (OCV) 24 and the feed 31. The constriction 32 is set to deliver helium at a certain rate, and the feed pressure of helium upstream from the constriction 32 is selected so that the helium calibration pressure is greater than the critical pressure of oxygen. The way the anti-flood system operates during a starting transient of the propulsion assembly is described below.

The combustion chamber is cooled in substantially the same manner as in the above-described prior art device. The HCV 25 is open for cooling purposes, the sweep valve 34 is open for sweeping with helium, and the OCV 24 is closed. Unlike the prior art device, helium can flow through the first heat exchanger 15 so long as the pressure of helium in the feed 31 is greater than the pressure of oxygen downstream from the OCV 24. Nevertheless, the valve 17a is closed.

After the combustion chamber 9 has been cooled, the starting transient of the propulsion assembly can begin. The OCV 24, the OGV 26, and the HGV 27 are opened. The turbopumps 7 and 8 are brought progressively into action by the combustion gas coming from the combustion of oxygen and hydrogen in the gas generator 6, and oxygen can penetrate into the combustion chamber 9. The sweep valve 34 remains open.

So long as the pressure of oxygen in the feed pipe 11 downstream from the OCV 24 is less than the helium calibration pressure, oxygen cannot penetrate into the inlet pipe 13a. Since the helium calibration pressure is selected to be higher than the critical pressure of oxygen, this avoids having oxygen present at a pressure lower than the critical pressure of oxygen in the first pressurizer circuit 13.

Because of the action of the turbopump 7, the pressure of oxygen in the feed pipe 11 increases. When it exceeds the helium calibration pressure, oxygen can penetrate into the inlet pipe 13a. The valve 17a is then opened. The opening of the valve 17a may be controlled by servo-control on the basis of the pressure of oxygen downstream from the OCV 24, or advantageously its instant of opening may be determined during development testing of the engine. Furthermore, because of the check valve 33, oxygen cannot enter into the feed 31. This prevents oxygen being present in the second tank 4. The oxygen entering into the inlet pipe 13a is in the supercritical state since its pressure is higher than the helium calibration pressure, which in turn is higher than the critical pressure of oxygen. The oxygen then enters into the first heat exchanger 15 where it remains in a single phase. At the outlet from the first heat exchanger, in the outlet pipe 13b, oxygen can thus pass through the valve 17a, can pass into the gaseous state, and can join the first tank 2 in order to pressurize it.

The action of the first turbopump 7 continues to increase the pressure of the oxygen in the oxygen feed pipe 11 until it reaches a steady speed nominal pressure. This nominal pressure, generally about 140 bar, is much higher than the critical pressure of oxygen. That is why, in order to avoid wasting helium, a few instants after the oxygen pressure exceeds the helium calibration pressure, the sweep valve 34 is closed. Since the pressure of oxygen in the feed pipe 11 remains higher than the critical pressure of oxygen, dynamic pressure control (in other words the anti-flood system) can be deactivated.

In the embodiment described, the heater through which the oxygen for pressurizing the first tank 2 passes is the heat exchanger 15, which co-operates with a pipe for transporting combustion gas from the gas generator 6. Nevertheless, the heat exchanger 15 may also co-operate with a pipe for transporting combustion gas taken from the combustion chamber 9 (tap-off type engine).

FIG. 3 shows a propulsion system 201 in another embodiment of the invention, made on the basis of an expander type engine. The operation of the anti-flood system is substantially the same as in the embodiment of FIG. 2 and it is not described again. The propulsion system 201 does not have a gas generator, nor does it have the pipes and valves that are associated therewith. In order to drive the turbopumps 7 and 8, a take-off pipe 236 takes vaporized hydrogen downstream from the heat exchanger 28 and causes it to flow through the turbines 7a and 8a, thereby driving the pumps 7b and 8b. By way of example, the pipe 236 causes vaporized hydrogen to flow through the hydrogen turbine 8a and then through the oxygen turbine 7a; the turbines may be passed through in the opposite order, the best order being determined by the person skilled in the art on the basis of experience. An exchange pipe 237 then connects the outlet from the oxygen turbine 7a to the first heat exchanger 15. Thus, in the first heat exchanger 15, heat is exchanged between the vaporized hydrogen entering via the exchange pipe 237 and the supercritical oxygen entering via the inlet pipe 13a. At the outlet from the first heat exchanger 15, hydrogen may be sent to the combustion chamber 9 to serve as fuel, or to the third tank 5 via a second pressurizer pipe 229, in order to pressurize it.

The heater could equally well not be a heat exchanger operating between two fluids, but could for example be an electrical heater.

Although the present invention is described with reference to specific embodiments, it is clear that various modifications and changes can be made to these embodiments without going beyond the general scope of the invention as defined by the claims. Consequently, the description and the drawings should be considered in a sense that is illustrative rather than restrictive.

1. A propulsion assembly for a rocket, comprising a tank configured to contain a propellant, an engine having a combustion chamber, a propellant feed pipe extending between the tank and the combustion chamber and having an isolation valve arranged therein, and a heater having an inlet connected to the feed pipe and an outlet connected to the tank, wherein the inlet of the heater comprises an inlet pipe connected firstly to the feed pipe downstream from the isolation valve and secondly to a neutral fluid feed.

2. A propulsion assembly according to claim 1, comprising means configured to maintain the neutral fluid in the neutral fluid feed at a pressure that is not less than the critical pressure of the propellant.

3. A propulsion assembly according to claim 1, wherein the neutral fluid feed comprises a check valve allowing fluid to flow in the feed only in the direction going towards the heater.

4. A propulsion assembly according to claim 1, comprising means for sweeping an injection head of the combustion chamber with the neutral fluid.

5. A propulsion assembly according to claim 1, wherein the neutral fluid is helium.

6. A propulsion assembly according to claim 1, wherein the propellant is oxygen.

7. A propulsion assembly according to claim 1, wherein the heater is a heat exchanger that co-operates with a pipe transporting another propellant.

8. A propulsion assembly according to claim 1, wherein the heater is a heat exchanger that co-operates with a pipe transporting combustion gases.
